(19) United States
(12) Patent Application Publication
(10) Pub. No.: US 2019/0085230 A1
(43) Pub. Date: Mar. 21, 2019

(54) COOLANT COMPOSITION AND METHOD OF OPERATING INTERNAL COMBUSTION ENGINE USING THE SAME

(71) Applicant: TOYOTA JIDOSHA KABUSHIKI KAISHA, Toyota-shi, Aichi-ken (JP)

(72) Inventors: Yasuaki KODAMA, Toyota-shi, Aichi-ken (JP); Shogo KAMENOUE, Wakayama-shi, Wakayama-ken (JP); Kazuhito YAEDA, Shizuoka-shi, Shizuoka-ken (JP); Yoichiro YOSHII, Shizuoka-shi, Shizuoka-ken (JP); Masayuki NAGASAWA, Shizuoka-shi, Shizuoka-ken (JP)

(73) Assignee: TOYOTA JIDOSHA KABUSHIKI KAISHA, Toyota-shi, Aichi-ken (JP)

(21) Appl. No.: 16/089,954

(22) PCT Filed: Apr. 3, 2017
(86) PCT No.: PCT/IB2017/000358

§ 371 Date: Sep. 28, 2018

(30) Foreign Application Priority Data
Apr. 4, 2016 (JP) 2016-075225

(51) Int. Cl. C09K 5/20

(52) U.S. Cl. CPC C09K 5/20

(57) ABSTRACT

A coolant composition includes a viscosity improving agent and a base. The viscosity improving agent includes at least one selected from an anionic surfactant represented by the following Formula (1) of R¹O—(R²O)ₘ—SO₃M and at least one selected from the group consisting of a cationic surfactant represented by the following Formula (2) and an amphoteric surfactant represented by the following Formula (3) or Formula (4). The base is formed of water and/or at least one alcohol selected from the group consisting of a monohydric alcohol, a dihydric alcohol, a trihydric alcohol, and a glycol monoalkyl ether, in which a shear viscosity is 8.5 mPa·s or higher at 25° C. and is 2.0 mPa·s or lower at 100° C.

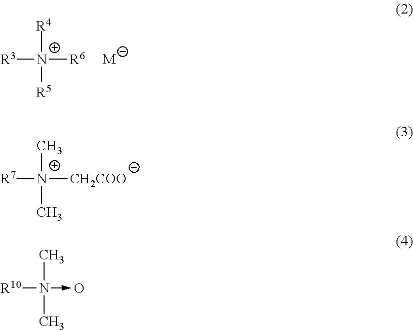

### BACKGROUND OF THE INVENTION

### 1. Field of the Invention

The present invention relates to a coolant composition capable of improving the fuel efficiency of an internal combustion engine, and a method of operating an internal combustion engine using the coolant composition.

### 2. Description of Related Art

As a coolant for cooling an automotive engine or the like, various products are known. Among these, water is preferable because it has the highest cooling performance as the coolant for an engine. However, pure water is frozen at 0° C. or lower. In consideration of the above-described circumstances, a coolant composition has been used, in which a glycol such as ethylene glycol as a base for obtaining anti-freezing properties is diluted with water to obtain a required freezing point, and various additives for preventing deterioration of metal, rubber, resins, and the like, which are used for, for example, an engine and a radiator, are optionally added thereto.

However, in a case where a glycol such as ethylene glycol is used, the viscosity of the coolant composition may significantly increase, in particular, at a low temperature. Accordingly, in general, a technique of reducing viscosity to improve fluidity at a low temperature has been disclosed (Japanese Patent Application Publication No. 2010-236064 (JP 2010-236064 A) and Japanese Patent Application Publication No. 9-227859 (JP 9-227859 A)). JP 2010-236064 A discloses a coolant composition which includes glycerin and a dicarboxylate having 4 to 8 carbon atoms as a major component. In this coolant composition, oral toxicity can be reduced while maintaining anticorrosion properties, and the freezing point and the viscosity can be reduced. JP 9-227859 A discloses an alcoholic coolant composition to which an aromatic carboxylate and/or a nitrite are/is added. As a result, cooling properties are improved, and rust prevention properties are excellent. Further, the safety is also high, and thus the alcoholic coolant composition can be used even in food manufacturing or the like.

However, in a case where the viscosity is reduced, the thickness of a boundary layer between a coolant and a bore wall decreases, and convection is likely to be generated. Therefore, the coolant is likely to absorb heat from the bore wall. As a result, cooling loss increases, which may cause deterioration in fuel efficiency. On the other hand, in order to reduce cooling loss by decreasing heat radiation, a configuration of increasing the concentration of a glycol such as ethylene glycol to increase the viscosity of a coolant at a low temperature may be adopted. In this case, however, cooling performance at a high temperature is insufficient, which may cause overheating.

For example, as techniques of improving the viscosity of a lubricant by the addition of a viscosity index improving agent, the following techniques are disclosed. Japanese Patent Application Publication No. 2011-137089 (JP 2011-137089 A) discloses a lubricant base oil including a polyol fatty acid ester which is synthesized from a polyol and a fatty acid or a fatty acid methyl ester. The lubricant base oil is biodegradable such that it has a low environmental load even when flowing into soil or rivers, has excellent fluidity at a low temperature, and has a high viscosity index. Japanese Patent Application Publication No. 2011-132285 (JP 2011-132285 A) discloses a viscosity index improving agent which includes a specific alkoxy compound, and a lubricant composition including the viscosity index improving agent. In the viscosity index improving agent, a viscosity index improving effect and shear stability are excellent. Japanese Patent Application Publication No. 2011-121991 (JP 2011-121991 A) discloses a low-viscosity lubricant composition in which a poly-α-olefin having a specific viscosity which is manufactured using a metallocene catalyst is used. In the low-viscosity lubricant composition, a viscosity index is high, fatigue resistance is excellent, and a decrease in viscosity caused by shearing is small. However, the viscosity index improving agent disclosed in the above techniques is added in order to reduce a decrease in viscosity at a high temperature while maintaining fluidity at a low temperature. Accordingly, even in a case where a solution to which the viscosity index improving agent is added is used as a coolant, cooling loss at a low temperature cannot be reduced, and cooling performance at a high temperature cannot be maintained.

In order to solve the above-described problems, for example, International Publication WO 2013/183161 discloses a coolant composition having a kinetic viscosity in a specific range and a method of operating an internal combustion engine using the coolant composition. By setting the kinetic viscosity of the coolant composition in the specific range, cooling loss at a low temperature can be reduced, and cooling performance at a high temperature can be maintained. Japanese Patent Application Publication No. 2014-189736 (JP 2014-189736 A) discloses a coolant composition including an alkyl ether and water and/or a water-soluble organic solvent. By further increasing the kinetic viscosity of a coolant immediately after the operation of an engine, cooling loss can be reduced such that the engine can be rapidly heated to an optimum temperature.

### SUMMARY OF THE INVENTION

However, as described above, various viscosity improving agents have been used as an additive of a coolant. However, in order to improve the fuel efficiency of an internal combustion engine, it is required that an increase in viscosity at a high temperature is small and cooling performance at a high temperature is maintained, and concurrently it is also required that warm-up performance at a low temperature is improved by increasing the viscosity and reducing cooling loss at a low temperature.

The invention provides a coolant composition capable of improving the fuel efficiency of an internal combustion engine, and a method of operating an internal combustion engine using the coolant composition.

The present inventors found that, by using a specific cationic surfactant or a specific amphoteric surfactant in combination with a specific anionic surfactant, an increase in viscosity at a high temperature is small and cooling performance at a high temperature can be maintained, and concurrently warm-up performance at a low temperature can be improved by increasing the viscosity and reducing cooling loss at a low temperature; as a result, the fuel efficiency of an internal combustion engine can be improved.

A first aspect of the invention relates to a coolant composition including a viscosity improving agent and a base. The viscosity improving agent includes at least one selected from an anionic surfactant represented by the following Formula (1) and at least one selected from the group consisting of a cationic surfactant represented by the following Formula (2) and an amphoteric surfactant represented by the following Formula (3) or Formula (4).

R¹O—(R²O)ₘ—SO₃M (1)

R¹ represents a linear or branched alkyl group having 16 to 24 carbon atoms or a linear or branched alkenyl group having 16 to 24 carbon atoms, R² represents an ethylene group or a propylene group, m represents an average addition molar number of R²O which is a number of 0.5 to 10, and M represents a cation or a hydrogen atom.

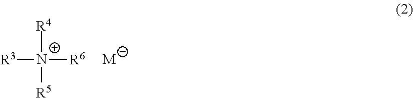

R³ represents an alkyl group or an alkenyl group having 10 to 24 carbon atoms, R⁴ represents an alkyl group having 1 to 24 carbon atoms, an alkenyl group having 2 to 24 carbon atoms, a benzyl group, or a hydrogen atom, R⁵ and R⁶ each independently represent a hydrogen atom, a methyl group, or an ethyl group, and M⁻ represents an anion.

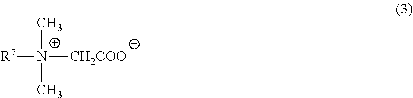

R⁷ represents an alkyl group having 10 to 24 carbon atoms, an alkenyl group having 10 to 24 carbon atoms or R⁸CONHR⁹—, R⁸ represents an alkyl group having 9 to 23 carbon atoms or an alkenyl group having 9 to 23 carbon atoms, and R⁹ represents an alkylene group having 1 to 5 carbon atoms.

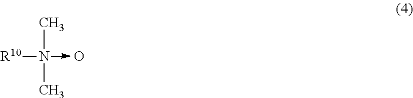

R¹⁰ represents an alkyl group having 10 to 24 carbon atoms or an alkenyl group having 10 to 24 carbon atoms.

The base is formed of water and/or at least one alcohol selected from the group consisting of a monohydric alcohol, a dihydric alcohol, a trihydric alcohol, and a glycol monoalkyl ether.

A shear viscosity of the coolant composition is 8.5 mPa·s or higher at 25° C. and is 2.0 mPa·s or lower at 100° C.

a content of the viscosity improving agent may be 0.05 to 10 parts by mass with respect to 100 parts by mass of the coolant composition.

a mass ratio (anionic surfactant/cationic or amphoteric surfactant) of the anionic surfactant to the cationic or amphoteric surfactant may be 0.1 to 50.

The coolant composition may further include a rust inhibitor.

A second aspect of the invention relates to a method of operating an internal combustion engine in which the above-described coolant composition is used as a coolant.

### DETAILED DESCRIPTION OF EMBODIMENTS

A coolant composition according to an embodiment of the present invention includes a viscosity improving agent. The viscosity improving agent includes an anionic surfactant represented by the following Formula (1) and at least one selected from the group consisting of a cationic surfactant represented by the following Formula (2) and an amphoteric surfactant represented by the following Formula (3) or Formula (4). As a result, the coolant composition has the specific shear viscosity at a low temperature and a high temperature. In the present invention, the low temperature refers to 25° C., and the high temperature refers to 100° C. In the coolant composition according to the embodiment, various viscosity improving agents may be used alone or in a combination of two or more kinds.

The anionic surfactant represented by Formula (1) which is used as the viscosity improving agent in the coolant composition according to the embodiment is represented by

R¹O—(R²O)ₘ—SO₃M (1)

where R¹ represents a linear or branched alkyl group having 16 to 24 carbon atoms or a linear or branched alkenyl group having 16 to 24 carbon atoms, R² represents an ethylene group or a propylene group, m represents an average addition molar number of R²O which is a number of 0.5 to 10, and M represents a cation or a hydrogen atom.

Regarding R¹, the alkyl group may be linear or branched and is preferably linear from the viewpoint of exhibiting the specific shear viscosity at the low temperature and the high temperature. The number of carbon atoms in the alkyl group is 16 to 24, preferably 18 to 22, and more preferably 20 to 22.

Regarding R¹, the alkenyl group may be linear or branched and is preferably linear from the viewpoint of exhibiting the specific shear viscosity at the low temperature and the high temperature. The number of carbon atoms in the alkenyl group is 16 to 24, preferably 18 to 22, and more preferably 20 to 22.

Specific examples of R¹ include an alkyl group such as a cetyl group, a margaryl group, an isostearyl group, a 2-heptylundecyl group, a stearyl group, an arachidyl group, a behenyl group, or a lignoceryl group; and alkenyl group such as an oleyl group. Among these, a cetyl group, a stearyl group, an arachidyl group, or a behenyl group is preferable, and a behenyl group is more preferable.

R² represents an ethylene group or a propylene group and preferably an ethylene group from the viewpoint of exhibiting the specific shear viscosity at the low temperature and the high temperature.

m represents an average addition molar number of R²O. From the viewpoint of exhibiting the specific shear viscosity at the low temperature and the high temperature, m represents a number of 0.5 to 10, preferably a number of 1 to 8, more preferably a number of 2 to 7, and still more preferably a number of 3 to 6.

M represents a cation or a hydrogen atom and preferably a cation. Specific examples of the cation include an alkali metal ion and an ammonium ion, and specific examples of the alkali metal include lithium, sodium, and potassium. Among these, sodium or potassium is preferable.

In an embodiment of the present invention, it is preferable to use an anionic surfactant represented by Formula (1) in which R¹ represents a linear alkyl group having 18 to 22 carbon atoms, R² represents an ethylene group, m which represents an average addition molar number of R²O represents a number of 2 to 7, and M represents a sodium ion or a potassium ion. In an embodiment of the present invention, it is more preferable to use an anionic surfactant represented by Formula (1) in which R¹ represents a linear alkyl group having 20 to 22 carbon atoms, R² represents an ethylene group, m which represents an average addition molar number of R²O represents a number of 3 to 6, and M represents a sodium ion or a potassium ion.

Specific examples of the anionic surfactant represented by the formula (1) include C₁₈H₃₇O—(CH₂CH₂O)₃—SO₃Na, C₈H₃₇O—(CH₂CH₂O)₃—SO₃K, C₂₂H₄₅O—(CH₂CH₂O)₄—SO₃Na, C₂₂H₄₅O—(CH₂CH₂O)₄—SO₃K, C₁₈H₃₇O—(CH₂CH₂O)₃—SO₃H, and C₂₂H₄₅O—(CH₂CH₂O)₄—SO₃H.

The cationic surfactant represented by Formula (2) which is used as the viscosity improving agent in the coolant composition according to the embodiment of the invention is represented by the following formula.

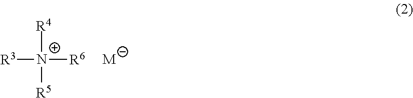

In Formula (2), R³ represents an alkyl group having 10 to 24 carbon atoms or an alkenyl group having 10 to 24 carbon atoms, R⁴ represents an alkyl group having 1 to 24 carbon atoms, an alkenyl group having 2 to 24 carbon atoms, a benzyl group, or a hydrogen atom, R⁵ and R⁶ each independently represent a hydrogen atom, a methyl group, or an ethyl group, and M⁻ represents an anion.

Regarding R³, the alkyl group may be linear or branched and is preferably linear from the viewpoint of exhibiting the specific shear viscosity at the low temperature and the high temperature. The number of carbon atoms in the alkyl group is 10 to 24, preferably 10 to 22, and more preferably 12 to 20.

Regarding R³, the alkenyl group may be linear or branched and is preferably linear from the viewpoint of exhibiting the specific shear viscosity at the low temperature and the high temperature. The number of carbon atoms in the alkenyl group is 10 to 24, preferably 10 to 22, and more preferably 12 to 20.

Regarding R⁴, the alkyl group may be linear or branched and is preferably linear from the viewpoint of exhibiting the specific shear viscosity at the low temperature and the high temperature. The number of carbon atoms in the alkyl group is 1 to 24, preferably 1 to 20, more preferably 1 to 10, and still more preferably 1 to 4.

Regarding R⁴, the alkenyl group may be linear or branched and is preferably linear from the viewpoint of exhibiting the specific shear viscosity at the low temperature and the high temperature. The number of carbon atoms in the alkenyl group is 2 to 24, preferably 2 to 20, more preferably 2 to 10, and still more preferably 2 to 4.

R⁵ and R⁶ each independently represent a hydrogen atom, a methyl group, or an ethyl group and preferably a hydrogen atom or a methyl group.

Specific examples of the anion represented by M⁻ include a halide ion such as a chloride ion, a bromide ion, or an iodide ion, a phosphate ion, an acetate ion, a lactate ion, a sulfate ion, and a monoalkyl sulfate ion. Among these, a chloride ion or an acetate ion is preferable.

In an embodiment of the invention, it is preferable to use a cationic surfactant represented by Formula (2) in which R³ represents an alkyl group having 10 to 20 carbon atoms or an alkenyl group having 10 to 20 carbon atoms, R⁴ represents a hydrogen atom, R⁵ and R⁶ each independently represent a hydrogen atom, a methyl group, or an ethyl group, and M⁻ represents an anion, and it is more preferable to use a cationic surfactant represented by Formula (2) in which R³ represents an alkyl group or an alkenyl group having 10 to 20 carbon atoms, R⁴ represents a hydrogen atom, R⁵ and R⁶ each independently represent a hydrogen atom, and M⁻ represents an anion.

In an embodiment of the invention, it is preferable to use a cationic surfactant represented by Formula (2) in which R³ represents an alkyl group having 10 to 20 carbon atoms, R⁴ represents an alkyl group having 1 to 5 carbon atoms, R⁵ and R⁶ each independently represent a hydrogen atom, a methyl group, or an ethyl group, and M⁻ represents an anion, and it is more preferable to use a cationic surfactant represented by Formula (2) in which R³ represents an alkyl group having 12 to 18 carbon atoms, R⁴ represents an alkyl group having 1 to 3 carbon atoms, R⁵ and R⁶ each independently represent a hydrogen atom, a methyl group, or an ethyl group, and M⁻ represents an anion.

In an embodiment of the invention, it is preferable to use a cationic surfactant represented by Formula (2) in which R³ represents an alkyl group having 10 to 24 carbon atoms, R⁴ represents an alkyl group having 10 to 24 carbon atoms, R⁵ and R⁶ each independently represent a hydrogen atom, a methyl group, or an ethyl group, and M⁻ represents an anion, and it is more preferable to use a cationic surfactant represented by Formula (2) in which R³ represents an alkyl group having 14 to 22 carbon atoms, R⁴ represents an alkyl group having 14 to 22 carbon atoms, R⁵ and R⁶ each independently represent a hydrogen atom, a methyl group, or an ethyl group, and M⁻ represents an anion.

Specific examples of the cationic surfactant represented by Formula (2) include coconut amine acetate, cetyl trimethyl ammonium chloride, distearyl dimethyl ammonium chloride, stearyl amine acetate, lauryl trimethyl ammonium chloride, stearyl trimethyl ammonium chloride, and alkyl benzyl dimethyl ammonium chloride.

The amphoteric surfactant represented by Formula (3) which is used as the viscosity improving agent in the coolant composition according to the embodiment of the invention is represented by the following formula.

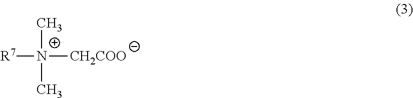

In Formula (3), R⁷ represents an alkyl group having 10 to 24 carbon atoms, an alkenyl group having 10 to 24 carbon atoms, or R⁸CONHR⁹—, R⁸ represents an alkyl group having 9 to 23 carbon atoms or an alkenyl group having 9 to 23 carbon atoms, and R⁹ represents an alkylene group having 1 to 5 carbon atoms.

Regarding R⁷, the alkyl group may be linear or branched and is preferably linear from the viewpoint of exhibiting the specific shear viscosity at the low temperature and the high temperature. The number of carbon atoms in the alkyl group is 10 to 24 and preferably 14 to 20.

Regarding R⁷, the alkenyl group may be linear or branched and is preferably linear from the viewpoint of exhibiting the specific shear viscosity at the low temperature and the high temperature. The number of carbon atoms in the alkenyl group is 10 to 24 and preferably 14 to 20.

Regarding R⁸ in R⁸CONHR⁹— defined as R⁷, the alkyl group may be linear or branched and is preferably linear from the viewpoint of exhibiting the specific shear viscosity at the low temperature and the high temperature. The number of carbon atoms in the alkyl group is 9 to 23, preferably 9 to 19, and more preferably 9 to 16. Regarding R⁸, the alkenyl group may be linear or branched and is preferably linear from the viewpoint of exhibiting the specific shear viscosity at the low temperature and the high temperature. The number of carbon atoms in the alkenyl group is 9 to 23, preferably 9 to 19, and more preferably 9 to 16.

Regarding R⁹ in R⁸CONHR⁹— defined as R⁷, the alkylene group may be linear or branched and is preferably linear from the viewpoint of exhibiting the specific shear viscosity at the low temperature and the high temperature. The number of carbon atoms in the alkylene group is 1 to 5 and preferably 2 to 4.

In an embodiment of the invention, it is preferable to use an amphoteric surfactant represented by Formula (3) in which R⁷ represents R⁸CONHR⁹—, R⁸ represents an alkyl group having 9 to 19 carbon atoms or an alkenyl group having 9 to 19 carbon atoms, and R⁹ represents an alkylene group having 1 to 5 carbon atoms, and it is more preferable to use an amphoteric surfactant represented by Formula (3) in which R⁷ represents R⁸CONHR⁹—, R⁸ represents an alkyl group having 9 to 16 carbon atoms or an alkenyl group having 9 to 16 carbon atoms, and R⁹ represents an alkylene group having 1 to 5 carbon atoms.

Specific examples of the amphoteric surfactant represented by Formula (3) include lauramidopropyl betaine, and stearamidopropyl betaine.

The amphoteric surfactant represented by Formula (4) which is used as the viscosity improving agent in the coolant composition according to the embodiment of the invention is represented by the following formula.

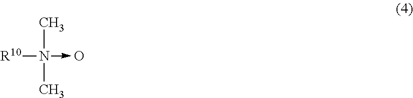

In Formula (4), R¹⁰ represents an alkyl group having 10 to 24 carbon atoms or an alkenyl group having 10 to 24 carbon atoms.

Regarding R¹⁰, the alkyl group may be linear or branched and is preferably linear from the viewpoint of exhibiting the specific shear viscosity at the low temperature and the high temperature. The number of carbon atoms in the alkyl group is 10 to 24, preferably 10 to 20, and more preferably 10 to 16.

Regarding R¹⁰, the alkenyl group may be linear or branched and is preferably linear from the viewpoint of exhibiting the specific shear viscosity at the low temperature and the high temperature. The number of carbon atoms in the alkenyl group is 10 to 24, preferably 10 to 20, and more preferably 10 to 16.

Specific examples of the amphoteric surfactant represented by Formula (4) include dimethyl lauryl amine oxide.

In the coolant composition according to the embodiment of the invention, as described above, the viscosity improving agent includes at least one selected from an anionic surfactant represented by the following Formula (1) and at least one selected from the group consisting of a cationic surfactant represented by the following Formula (2) and an amphoteric surfactant represented by the following Formula (3) or Formula (4). As a result, the shear viscosity can be adjusted to be in the predetermined range. The shear viscosity at 25° C. can be adjusted to be high using, for example, a method of increasing the content of the viscosity improving agent, a method of increasing the content of the anionic surfactant represented by Formula (1), or in a case where the base includes an alcohol, a method of increasing the content of the alcohol. The shear viscosity at 100° C. can be adjusted to be low using, for example, a method of decreasing the content of the viscosity improving agent, or in a case where the base includes an alcohol, a method of decreasing the content of the alcohol.

The content of the anionic surfactant represented by Formula (1) with respect to 100 parts by mass of the coolant composition according to the embodiment is preferably 0.01 parts by mass or more, more preferably 0.1 parts by mass or more, still more preferably 0.15 parts by mass or more, still more preferably 0.25 parts by mass, and still more preferably 0.35 parts by mass or more from the viewpoint of adjusting the shear viscosity of the coolant composition at the low temperature and the high temperature (in particular, at the low temperature) to be in the predetermined range, and is preferably 9.995 parts by mass or less, more preferably 3 parts by mass or less, still more preferably 2 parts by mass or less, still more preferably 1 part by mass, and still more preferably 0.5 parts by mass from the viewpoints of improving cooling performance and suppressing deposition. From these viewpoints, the content of the anionic surfactant represented by Formula (1) is preferably 0.01 to 9.995 parts by mass, more preferably 0.1 to 3 parts by mass, still more preferably 0.15 to 2 parts by mass, still more preferably 0.25 to 1 part by mass, and still more preferably 0.35 to 0.5 parts by mass.

The content of the cationic surfactant represented by Formula (2) and the amphoteric surfactant represented by Formula (3) or (4) with respect to 100 parts by mass of the coolant composition according to the embodiment is preferably 0.005 parts by mass or more, more preferably 0.007 parts by mass or more, still more preferably 0.01 parts by mass or more, still more preferably 0.03 parts by mass, and still more preferably 0.05 parts by mass or more from the viewpoint of adjusting the shear viscosity of the coolant composition at the low temperature and the high temperature to be in the predetermined range when used in combination with the anionic surfactant, and is preferably 9.99 parts by mass or less, more preferably 1 part by mass or less, still more preferably 0.5 parts by mass or less, still more preferably 0.3 parts by mass or less, and still more preferably 0.1 parts or less by mass from the viewpoints of improving cooling performance and suppressing deposition. From these viewpoints, the content of the cationic surfactant represented by Formula (2) and the amphoteric surfactant represented by Formula (3) or (4) is preferably 0.005 to 9.99 parts by mass, more preferably 0.007 to 1 part by mass, still more preferably 0.01 to 0.5 parts by mass, still more preferably 0.03 to 0.3 parts by mass, and still more preferably 0.05 to 0.1 parts by mass.

The content of the viscosity improving agent with respect to 100 parts by mass of the coolant composition according to the embodiment is preferably 0.05 parts by mass or more, more preferably 0.1 parts by mass or more, still more preferably 0.2 parts by mass or more, still more preferably 0.3 parts by mass or more, and still more preferably 0.35 parts by mass or more from the viewpoint of adjusting the shear viscosity of the coolant composition at the low temperature and the high temperature to be in the predetermined range, and is preferably 10 parts by mass or less, more preferably 5 parts by mass or less, still more preferably 3 parts by mass or less, still more preferably 1 part by mass or less, and still more preferably 0.75 parts by mass or less from the viewpoints of improving cooling performance and suppressing deposition. From these viewpoints, the content of the viscosity improving agent is preferably 0.05 to 10 parts by mass, more preferably 0.1 to 5 parts by mass, still more preferably 0.2 to 3 parts by mass, still more preferably 0.3 to 1 part by mass, and still more preferably 0.35 to 0.75 parts by mass.

In the coolant composition according to the embodiment, a mass ratio of the anionic surfactant to the cationic or amphoteric surfactant (anionic surfactant/cationic or amphoteric surfactant) is preferably 0.1 or higher, more preferably 0.5 or higher, still more preferably 5 or higher, still more preferably 15 or higher, and still more preferably 25 or higher from the viewpoint of adjusting the shear viscosity of the coolant composition at the low temperature and the high temperature to be in the predetermined range, and is preferably 50 or lower, more preferably 45 or lower, and still more preferably 40 or lower from the viewpoints of improving cooling performance and suppressing deposition. From these viewpoints, the mass ratio of the anionic surfactant to the cationic or amphoteric surfactant (anionic surfactant/cationic or amphoteric surfactant) is preferably 0.1 to 50, more preferably 0.5 to 50, still more preferably 5 to 45, still more preferably 15 to 45, and still more preferably 25 to 40.

In a case where a plurality of anionic surfactants represented by Formula (1) are present, the part(s) by mass of the anionic surfactants represents the total part(s) by mass of the anionic surfactants represented by Formula (1). In a case where a plurality of cationic surfactants represented by Formula (2) and a plurality of amphoteric surfactants represented by Formula (3) or (4) are present, the part(s) by mass of the cationic surfactants and the amphoteric surfactants represents the total parts by mass of the cationic surfactants represented by Formula (2) and the amphoteric surfactants represented by Formula (3) or (4).

The shear viscosity of the coolant composition according to the embodiment is 8.5 mPa·s or higher at 25° C. and is 2.0 mPa·s or lower at 100° C.

The shear viscosity of the coolant composition according to the embodiment at 25° C. is preferably 8.5 mPa·s or higher from the viewpoint of suppressing cooling loss at the low temperature, and is preferably 3000 mPa·s or lower from the viewpoints of avoiding a load on a water pump and suppressing deterioration in the fuel efficiency of an internal combustion engine. From these viewpoints, the shear viscosity of the coolant composition according to the embodiment at 25° C. is preferably 8.5 to 3000 mPa·s, more preferably 15 to 2000 mPa·s, still more preferably 25 to 1000 mPa·s, still more preferably 35 to 500 mPa·s, still more preferably 45 to 300 mPa·s, still more preferably 55 to 200 mPa·s, and still more preferably 65 to 100 mPa·s.

From the viewpoint of maintaining cooling performance at the high temperature and preventing overheating, the shear viscosity of the coolant composition according to the embodiment at 100° C. is preferably 2.0 mPa·s or lower, more preferably 0.2 to 1.8 mPa·s, still more preferably 0.3 to 1.6 mPa·s, still more preferably 0.4 to 1.4 mPa·s, and still more preferably 0.5 to 1.2 mPa·s. The cooling performance of the coolant composition can be evaluated, for example, by evaluating the heat transmittance of a radiator. In a case where a coolant consists of 100% of water, the shear viscosity thereof at 100° C. is 0.3 mPa·s.

By further adding a viscosity improving agent such as a thickener or a viscosity reducer in addition to the viscosity improving agent according to the invention, the shear viscosity may be adjusted to be 8.5 mPa·s or higher at 25° C. and 2.0 mPa·s or lower at 100° C. The shear viscosity can be measured using a method described below in Examples.

The coolant composition according to the embodiment includes a base.

The base used in the coolant composition according to the embodiment is formed of water and/or at least one alcohol selected from the group consisting of alcohols such as a monohydric alcohol, a dihydric alcohol, and a trihydric alcohol, and a glycol monoalkyl ether.

It is preferable that the coolant composition according to the embodiment includes a base having anti-freezing properties. However, in a case where anti-freezing properties are not required, the base may consist of only water.

Examples of the monohydric alcohol include a monohydric alcohol having 1 to 8 carbon atoms such as methanol, ethanol, propanol, butanol, pentanol, hexanol, heptanol, or octanol. Among these, one kind may be used alone, or a mixture of two or more kinds may be used.

Examples of the dihydric alcohol include a dihydric alcohol having 2 to 8 carbon atoms such as ethylene glycol, diethylene glycol, triethylene glycol, propylene glycol, 1,3-propanediol, 1,4-butanediol, 1,3-butanediol, 1,5-pentanediol, or hexylene glycol. Among these, one kind may be used alone, or a mixture of two or more kinds may be used.

Examples of the trihydric alcohol include a trihydric alcohol having 3 to 6 carbon atoms such as glycerin, trimethylolethane, trimethylolpropane, 5-methyl-1,2,4-heptanetriol, or 1,2,6-hexanetriol. Among these, one kind may be used alone, or a mixture of two or more kinds may be used.

Specific examples of the glycol monoalkyl ether include ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, and tetraethylene glycol monobutyl ether. Among these, one kind may be used alone, or a mixture of two or more kinds may be used. The number of carbon atoms in the alkyl group of the glycol monoalkyl ether is preferably 1 to 4, more preferably 1 or 2. The number of carbon atoms in the glycol is preferably 2 to 6 and more preferably 2.

Among the bases, ethylene glycol, propylene glycol, or 1,3-propanediol is preferable from the viewpoints of handleability, price, and availability.

Therefore, it is preferable that the base includes at least one selected from the group consisting of ethylene glycol, propylene glycol, 1,3-propanediol, and water. It is more preferable that the base includes ethylene glycol and water. As water used as the base, ion exchange water is preferable.

The content of the base with respect to 100 parts by mass of the coolant composition according to the embodiment is preferably 50 parts by mass or more, more preferably 75 parts by mass or more, still more preferably 80 parts by mass or more, and still more preferably 90 parts by mass or more from the viewpoint of functioning as a coolant, and is preferably 99.92 parts by mass or less, more preferably 99.9 parts by mass or less, still more preferably 99 parts by mass or less, and still more preferably 98 parts by mass or less from the viewpoint of adding the viscosity improving agent or an alkali metal compound. From these viewpoints, the content of the base is preferably 50 to 99.92 parts by mass, more preferably 80 to 99.9 parts by mass, still more preferably 90 to 99.9 parts by mass, still more preferably 90 to 99 parts by mass, and still more preferably 90 to 98 parts by mass.

When the base includes water and the alcohol, a mixing ratio of water to the alcohol can be appropriately adjusted in consideration of anti-freezing properties and inflammability. From the viewpoint of preventing ignition, the mass ratio (water:alcohol) of water to the alcohol in the base is preferably 20:80 to 90:10 and more preferably 40:60 to 75:25.

It is preferable that the coolant composition according to the embodiment is obtained by mixing the following components with each other, the components including: the base; the viscosity improving agent; optionally a rust inhibitor; and optionally additives other than the rust inhibitor (hereinafter, also referred to as “the other additives”). It is more preferable that, after being mixed, the components are heated to a temperature (preferably 60° C. or higher and more preferably 80° C. or higher; preferably 100° C. or lower), are optionally stirred and dissolved, and then are cooled to room temperature (20° C.).

In order to efficiently suppress corrosion of metal used in an engine coolant passage, the coolant composition according to the embodiment may include at least one rust inhibitor within a range where the shear viscosity is not affected. Examples of the rust inhibitor include phosphoric acid and salts thereof; aliphatic carboxylic acids and salts thereof; aromatic carboxylic acids and salts thereof; triazoles; thiazoles; silicates; nitrates; nitrites; borates; molybdates; and amine salts. Among these, one kind may be used alone, or a mixture of two or more kinds may be used. The content of the rust inhibitor is preferably 0.01 to 8 parts by mass, more preferably 0.05 to 7 parts by mass, still more preferably 0.1 to 6 parts by mass, and still more preferably 0.1 to 5 parts by mass with respect to 100 parts by mass of the coolant composition.

In the coolant composition according to the embodiment, optionally, the other additives can be added to the base in addition to the viscosity improving agent within a range where the effects of the embodiment do not deteriorate. Examples of the other additives include a pH adjuster, a defoaming agent, a colorant, and a bittering agent. The total mixing amount of the other additives is typically 10 parts by mass or less and preferably 5 parts by mass or less with respect to 100 parts by mass of the coolant composition.

The coolant composition according to the embodiment may be obtained by adding the base and optionally the other additives to a highly concentrated composition such that the concentration of the viscosity improving agent is diluted to ½ to 1/100, the concentrated composition including: the viscosity improving agent; optionally a rust inhibitor and a solvent; and additives other than the rust inhibitor.

The solvent included in the concentrated composition according to the embodiment may be the same as or different from the base added to obtain the coolant composition. For example, after the concentrated composition is initially obtained using an alcohol such as ethylene glycol as the solvent, the obtained concentrated composition may be diluted by adding water as the residual base. The content of the viscosity improving agent with respect to 100 parts by mass of the concentrated composition is preferably 0.1 to 99 parts by mass, more preferably 1 to 90 parts by mass, and still more preferably 3 to 50 parts by mass. The content of the solvent with respect to 100 parts by mass of the concentrated composition is preferably 1 to 99.9 parts by mass, more preferably 50 to 99 parts by mass, and still more preferably 70 to 95 parts by mass.

In general, the coolant composition according to the embodiment can be used as a coolant and is preferably used as a coolant for an internal combustion engine. Therefore, the embodiment also relates to a method of operating an internal combustion engine in which the coolant composition according to the embodiment is used as a coolant (hereinafter, also referred to as “method of operating an internal combustion engine according to the embodiment”). In the method of operating an internal combustion engine according to the embodiment, the fuel efficiency of an internal combustion engine can be improved. The coolant composition according to the embodiment can be used as a coolant of a battery stack, a fuel cell stack, or the like.

Hereinafter, the invention will be described in more detail using Examples. However, the invention is not limited to the range of Examples.

### Examples 1 to 10 and Comparative Examples 1 to 3

Materials in a formula shown in Table 1 below were added and were stirred and mixed to obtain a LLC. In Table 1, sebacic acid (manufactured by Kokura Synthetic Industries Ltd.) was used as the rust inhibitor, and potassium hydroxide (47% product; manufactured by Osaka Soda Co., Ltd.) was used as the pH adjuster.

In each of Examples and Comparative Examples, components shown in Table 2 below were mixed, were left to stand in a thermostatic chamber at 90° C. for 1 hour, and were stirred to prepare a coolant composition.

TABLE 1

| Material | Mixing Amount (wt %) |
|---|---|
| Ethylene Glycol | 90.6 |
| Water | 1.2 |
| Rust Inhibitor | 4.2 |
| pH Adjuster | 4 |

The shear viscosity of the coolant composition obtained in each of Examples 1 to 10 and Comparative Examples 1 to 3 was measured at 25° C. and 100° C.

<Method of Measuring Shear Viscosity>

The coolant composition prepared in each of Examples and Comparative Examples was left to stand in a thermostatic chamber set to a measurement temperature for 1 hour. Next, using a rheometer (Model: MCR-302; manufactured by Anton Parr GmbH) and an attachment (CP50-1, manufactured by Anton Parr GmbH), the viscosity of the coolant composition at 25° C. was measured at a rotating speed of 22/s, and the viscosity of the coolant composition at 100° C. was measured at a rotating speed of 100/s. The results are shown in Table 2.

TABLE 2

| | | Example 1 | Example 2 | Example 3 | Example 4 | Example 5 | Example 6 | Example 7 |
|---|---|---|---|---|---|---|---|---|
| LLC | mass % | 53 | 53 | 53 | 53 | 53 | 53 | 53 |
| Water | mass % | 46.99 | 46.9 | 46.8 | 46.7 | 46.95 | 46.9 | 46.95 |
| Anionic Surfactant 1 | mass % | 0.39 | 0.3 | 0.2 | 0.1 | 0.15 | 0.1 | 0.35 |
| Cationic Surfactant 1 | mass % | 0.01 | 0.1 | 0.2 | 0.3 | 0.05 | 0.1 | |
| Cationic Surfactant 2 | | | | | | | | 0.05 |
| Cationic Surfactant 3 | | | | | | | | |
| Amphoteric Surfactant 1 | | | | | | | | |
| Amphoteric Surfactant 2 | | | | | | | | |
| Total Amount of | mass % | 0.4 | 0.4 | 0.4 | 0.4 | 0.2 | 0.2 | 0.4 |
| Surfactants | | | | | | | | |
| Anionic Surfactant/ | — | 39 | 3 | 1 | 0.33 | 3 | 1 | 7 |
| Cationic or Amphoteric | | | | | | | | |
| Surfactant (Mass Ratio) | | | | | | | | |
| Thickener 1 | mass % | | | | | | | |
| Thickener 2 | mass % | | | | | | | |
| Total Amount of | mass % | | | | | | | |
| Thickener | | | | | | | | |
| Shear Viscosity | mPa · s | 76 | 48 | 41.3 | 17 | 14 | 30 | 71 |
| (25° C., 22/s) | | | | | | | | |
| Shear Viscosity | mPa · s | 1 | 1.9 | 1.54 | 1 | 1.3 | 1.5 | 1.9 |
| (100° C., 100/s) | | | | | | | | |

| | | | | Example | Comparative | Comparative | Comparative |
|---|---|---|---|---|---|---|---|
| | | Example 8 | Example 9 | 10 | Example 1 | Example 2 | Example 3 |
| LLC | mass % | 53 | 53 | 53 | 53 | 53 | 53 |
| Water | mass % | 46.95 | 46.98 | 46.95 | 47 | 46.9 | 46 |
| Anionic Surfactant 1 | mass % | 0.35 | 0.38 | 0.35 | | | |
| Cationic Surfactant 1 | mass % | | | | | | |
| Cationic Surfactant 2 | | | | | | | |
| Cationic Surfactant 3 | | 0.05 | | | | | |
| Amphoteric Surfactant 1 | | | 0.02 | | | | |
| Amphoteric Surfactant 2 | | | | 0.05 | | | |
| Total Amount of | mass % | 0.4 | 0.4 | 0.4 | | | |
| Surfactants | | | | | | | |
| Anionic Surfactant/ | — | 7 | 19 | 7 | | | |
| Cationic or Amphoteric | | | | | | | |
| Surfactant (Mass Ratio) | | | | | | | |
| Thickener 1 | mass % | | | | | 0.1 | |
| Thickener 2 | mass % | | | | | | 1 |
| Total Amount of | mass % | | | | 0 | 0.1 | 1 |
| Thickener | | | | | | | |
| Shear Viscosity | mPa · s | 31 | 88 | 74 | 3.7 | 43 | 11 |
| (25° C., 22/s) | | | | | | | |
| Shear Viscosity | mPa · s | 1.4 | 1 | 1.1 | 0.9 | 11 | 2.6 |
| (100° C., 100/s) | | | | | | | |

Anionic Surfactant 1: C₂₂H₄₅O—(CH₂CH₂O)₄—SO₃Na
Cationic Surfactant 1: coconut amine acetate (R³: an alkyl group or an alkenyl group having 12 to 18 carbon atoms, R⁴, R⁵, R⁶: a hydrogen atom, M: CH₃COO—)
Cationic Surfactant 2: cetyl trimethyl ammonium chloride (R³: an alkyl group having 16 carbon atoms, R⁴, R⁵, R⁶: a methyl group, M: a chloride ion)
Cationic Surfactant 3: distearyl dimethyl ammonium chloride (R³, R⁴: an alkyl group having 18 carbon atoms, R⁵, R⁶: a methyl group, M: a chloride ion)
Amphoteric Surfactant 1: lauramidopropyl betaine (R⁸: an alkyl group having 11 carbon atoms, R⁹: an alkylene group having 3 carbon atoms)
Amphoteric Surfactant 2: dimethyl lauryl amine oxide (R¹⁰: an alkyl group having 12 carbon atoms)
Thickener 1: xanthan gum
Thickener 2: polyvinyl alcohol (average polymerization degree: 1700)

It can be seen from Table 2 that, in all the coolant compositions according to Examples 1 to 10, the viscosity at 25° C. was increased and the viscosity at 100° C. was equal as compared to those in the coolant composition according to Comparative Example 1. It can be seen that, in the coolant composition according to Comparative Example 2, the viscosity at 25° C. was increased but the viscosity at 100° C. was also increased. It can be seen that, in the coolant composition according to Comparative Example 3, an increase in the viscosity at 25° C. was small and the viscosity at 100° C. was increased.

The coolant composition according to the embodiment is preferably used for cooling an internal combustion engine (including a hybrid system) of a vehicle such as an automobile or a working vehicle (for example, a truck or a heavy machinery), a ship, an airplane, a power generator, or a heating and cooling system and for cooling a battery or a fuel cell.

What is claimed is:

1. A coolant composition comprising a viscosity improving agent and a base, wherein
the viscosity improving agent includes at least one selected from an anionic surfactant represented by the following Formula (1) and at least one selected from the group consisting of a cationic surfactant represented by the following Formula (2) and an amphoteric surfactant represented by the following Formula (3) or Formula (4),
R¹O—(R²O)ₘ—SO₃M (1)
where R¹ represents a linear or branched alkyl group having 16 to 24 carbon atoms or a linear or branched alkenyl group having 16 to 24 carbon atoms, R² represents an ethylene group or a propylene group, m represents an average addition molar number of R²O which is a number of 0.5 to 10, and M represents a cation or a hydrogen atom, 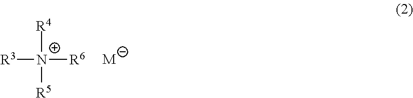
where R³ represents an alkyl group having 10 to 24 carbon atoms or an alkenyl group having 10 to 24 carbon atoms, R⁴ represents an alkyl group having 1 to 24 carbon atoms, an alkenyl group having 2 to 24 carbon atoms, a benzyl group, or a hydrogen atom, R⁵ and R⁶ each independently represent a hydrogen atom, a methyl group, or an ethyl group, and M⁻ represents an anion, 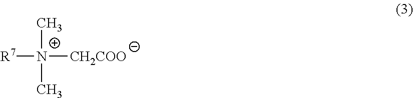
where R⁷ represents an alkyl group having 10 to 24 carbon atoms, an alkenyl group having 10 to 24 carbon atoms, or R⁸CONHR⁹—, R⁸ represents an alkyl group or an alkenyl group having 9 to 23 carbon atoms, and R⁹ represents an alkylene group having 1 to 5 carbon atoms, 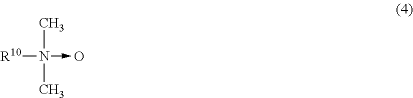
where R¹⁰ represents an alkyl group having 10 to 24 carbon atoms or an alkenyl group having 10 to 24 carbon atoms,
the base is formed of water and/or at least one alcohol selected from the group consisting of a monohydric alcohol, a dihydric alcohol, a trihydric alcohol, and a glycol monoalkyl ether, and
a shear viscosity of the coolant composition is 8.5 mPa·s or higher at 25° C. and is 2.0 mPa·s or lower at 100° C.

2. The coolant composition according to claim 1, wherein
a content of the viscosity improving agent is 0.05 to 10 parts by mass with respect to 100 parts by mass of the coolant composition.

3. The coolant composition according to claim 1, wherein
a mass ratio of the anionic surfactant to the cationic or amphoteric surfactant is 0.1 to 50.

4. The coolant composition according to claim 1, further comprising:
a rust inhibitor.

5. A method of operating an internal combustion engine wherein the coolant composition according to claim 1 is used as a coolant.
